(19) United States
(12) Patent Application Publication
(10) Pub. No.: US 2015/0316960 A1
(43) Pub. Date: Nov. 5, 2015

(54) MULTI-FUNCTIONAL TABLET ELECTRONIC DEVICE RECEIVING BAG

(71) Applicant: Li-Mi Tseng, New Taipei City (TW)

(72) Inventor: Li-Mi Tseng, New Taipei City (TW)

(21) Appl. No.: 14/267,921

(22) Filed: May 2, 2014

(51) Int. Cl. G06F 1/16; G02B 7/02; A45C 11/00; G02B 7/182

(52) U.S. Cl. CPC G06F 1/1628; G02B 7/1821; G02B 7/023; A45C 11/00; A45C 2011/003

(57) ABSTRACT

A multi-functional tablet electronic device receiving bag comprises: a box body having a receiving space for receiving a tablet electronic device; a cover for covering upon the box body from a front side or a back side of the box body; a pivotal portion installed between the box body and the cover for connecting the box body to the cover; the pivotal portion serving to cause that when the cover is opened from the box body, it can be retained at a predetermined angle and does not fall down to cover the box body again; and a mirror assembly pivotal to the cover so that the mirror assembly is rotatable along the cover and can be positioned at a predetermined angle. The tablet electronic device is one of a handset and a tablet computer.

### FIELD OF THE INVENTION

The present invention related to receiving bags for tablet electronic devices, and in particular to a multi-functional tablet electronic device receiving bag.

### BACKGROUND OF THE INVENTION

Conventionally, there are several different bogs for receiving tablet electronic devices. One is a protection box for enclosing an electronic device for preventing it from scraping and the protection box having a light and compact size. Another is a bag with a zipper for protecting a tablet electronic device receiving therein. However, above mentioned bags have simple structures for receiving and protecting an electronic device therein without providing any other special function. Furthermore, in the prior art bags, the structure of the connecting pivotal portions for connecting two sides of the bags is simple and soft, and thus cannot retain at a fix angle as the cover of the bag is opened.

Therefore, based on the understanding about the prior art bags for receiving electronic devices, the inventor of the present invention serves to provide a bag for receiving electronic device with a connecting portion between two sides of the bag so that the two sides of the bag can be opened and retained at a desired angle. Furthermore, a mirror assembly is provided to the bag, wherein the bag assembly is capable to be retained fixedly to a desire angle to reflect or transmit images from different aspects to the users. In use of the present invention, no hand is used to support the whole structure, while a pivotal portion with retaining function is used to support the cover or mirror assembly.

### SUMMARY OF THE INVENTION

Accordingly, the object of the present invention is to provide a multi-functional tablet electronic device receiving bag, in that the mirror assembly, the cover, the box body are combined by using a pivotal portion and a pivotal unit so that they are formed as an integral body, while they be expanded to desired angles and fixed at that angles. Therefore, the bag of the present invention has both the function of receiving a tablet electronic device and a mirror assembly. The pivotal portion may be positioned at a desired angle with respect to the box body without falling down to an original position, and moreover, the pivotal portion can be opened at different orientations. Furthermore, in the present invention, the mirror assembly is pivotally connected to the cover and can be positioned at a desired angle with respect to the box body. Therefore, a user can lift the mirror assembly from the cover to get images from the mirror assembly.

To achieve above object, the present invention provides multi-functional tablet electronic device receiving bag, comprising: a box body having a receiving space for receiving a tablet electronic device; a cover for covering upon the box body from a front side or a back side of the box body; a pivotal portion installed between the box body and the cover for connecting the box body to the cover; the pivotal portion serving to cause that when the cover is opened from the box body, it can be retained at predetermined angle and does not fall down to cover the box body 10 again; and a mirror assembly pivotal to the cover so that the mirror assembly is rotatable along the cover and can be positioned at predetermined angle;

### BRIEF DESCRIPTION OF THE DRAWINGS

FIG. 1 is an exploded view of the present invention.

FIG. 2 is a structural plane view showing the opening of the present invention.

FIG. 3 is a structural assembly view of the present invention showing that the present invention is in an open state.

FIG. 4 is a structural assembly view showing that an opening operation of the present invention.

FIG. 5 is a lateral view showing that in the present invention, the cover can rotate through an angle larger than 180 degrees.

FIG. 6 is a structural lateral view showing that in the present invention, the mirror assembly can rotate through an angle larger than 180 degrees.

FIG. 7 shows that the pivotal portion of the present invention is formed at a transversal side of the box body.

FIG. 8 shows that the rotation track of the mirror assembly is vertical to that of the cover in the present invention.

FIG. 9 shows that the present invention further has a connection portion.

FIG. 10 shows a lateral view of the connecting portion of the present invention.

FIG. 11 shows the embodiment about the pivotal portion of the present invention.

FIG. 12 shows another embodiment about the pivotal portion of the present invention.

FIG. 13 shows one embodiment of the present invention, in that the box body, cover and mirror assembly have elliptical shapes.

FIG. 14 is an embodiment where the cover is installed at a backside of the box body.

### DETAILED DESCRIPTION OF THE INVENTION

In order that those skilled in the art can further understand the present However, these descriptions and the appended drawings are only used to skilled in the art to understand the objects, features, and characteristics of the present invention, but not to be used to confine the scope and spirit of the present invention defined in the appended claims.

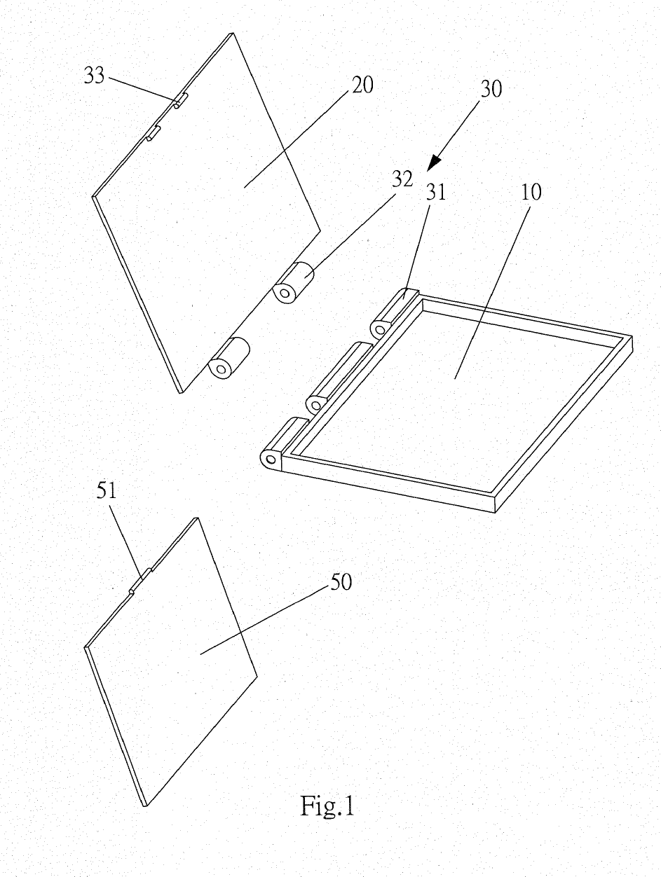

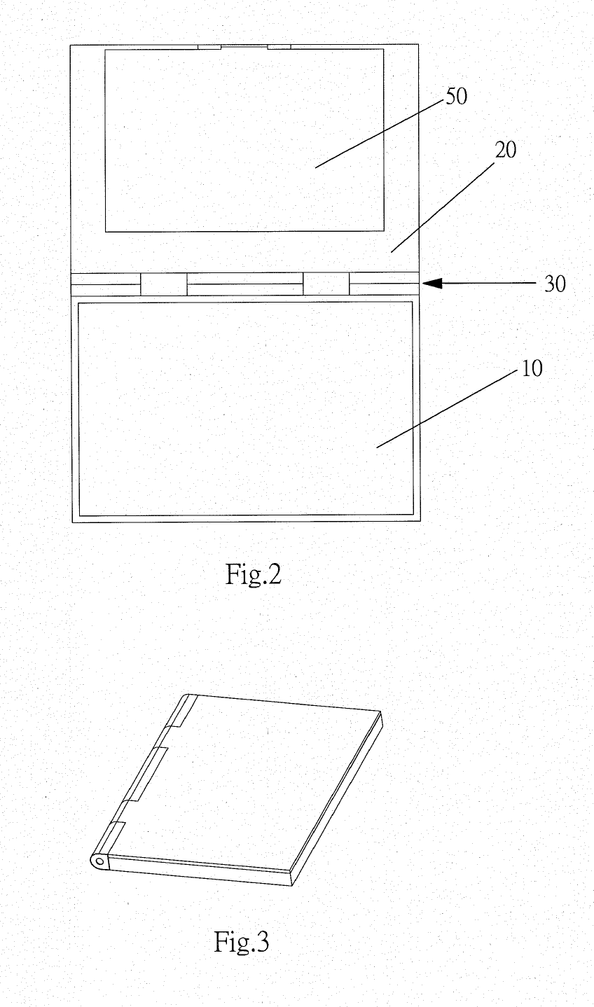

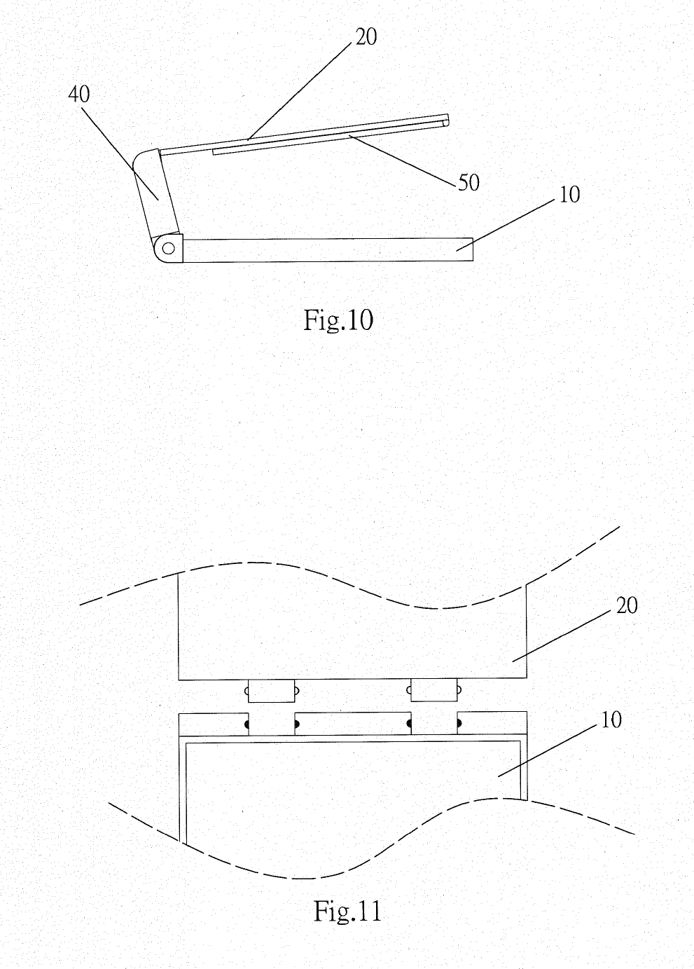

With reference to FIGS. 1 to 14, the multi-functional receiving bag for tablet electronic device of the present invention comprises the following elements.

A box body 10 has a receiving space for receiving a tablet electronic device (such as a handset, or a tablet computer, etc.). Preferably the box body 10 is a rectangular box body.

A cover 20 serves for covering upon the box body 10 from a front side or a back side of the box body 10. Preferably, the cover 20 has a shape like that of the box body 10.

A pivotal portion 30 is installed between the box body 10 and the cover 20 for connecting the box body 10 to the cover 20. The pivotal portion 30 serves to cause that when the cover is opened from the box body 10, it can be retained at a desired angle and does not fall down to cover the box body 10 again.

With reference to FIG. 1, the pivotal portion 30 of the present invention includes the following elements of:

a box side pivotal unit 31;

a cover side pivotal unit pivotal to the box side pivotal unit 31 so that the cover side pivotal unit 32 is rotatable along the box side pivotal unit 31 desired angle to cause that the cover 20 is fixed at the angle without covering the box body 10 again.

Referring to FIG. 9, another embodiment of the present invention is illustrated, wherein the pivotal portion 30 includes the following elements a box side pivotal unit 31;

a cover side pivotal unit 32; and

a connecting portion 40 connected between the box side pivotal unit 31 and the cover side pivotal unit 32; the box side pivotal unit 31 being pivotal to one side of the connecting portion 40, and the cover side pivotal unit 32 is pivotal to an opposite side of the connecting portion 40.

This causes that the whole structure of the present invention has a great volume for receiving the electronic device therein.

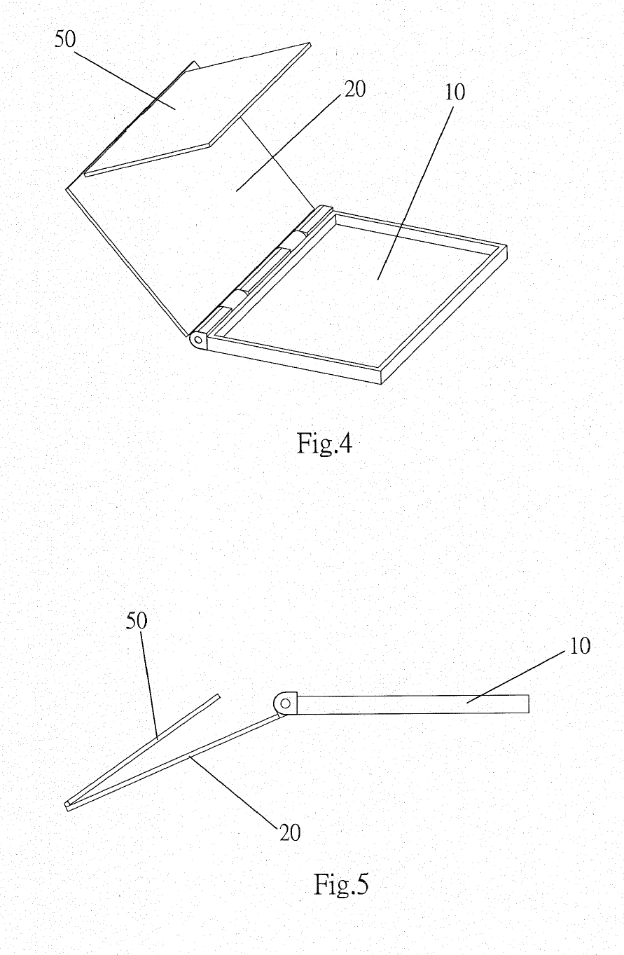

With reference to FIG. 4, it is illustrated that the pivotal portion 30 is connected to a longitudinal (long) side of the box body 10 or connected to a transversal (short) side of the box body 10.

A mirror assembly 50 is pivotal to the cover 20 so that the mirror assembly 50 is rotatable along the cover 20 to be positioned at a desired angle. The mirror assembly 50 may be any kind of mirrors, such reflecting mirror, double side mirrors, or lenses (including convex lenses or concave lenses), etc. One side of the mirror assembly 50 is extended with a connecting unit 51 for connecting the mirror assembly 50 to a pivotal unit 33 at one side of the cover 20 so that the mirror assembly 50 is rotatable with respect to the cover 20 along the pivotal unit 33.

With reference to FIG. 4, the mirror assembly 50 is formed at a longitudinal (long) side of the cover 20 or as illustrated in FIG. 7, is formed at a transversal (short) side of the cover 20.

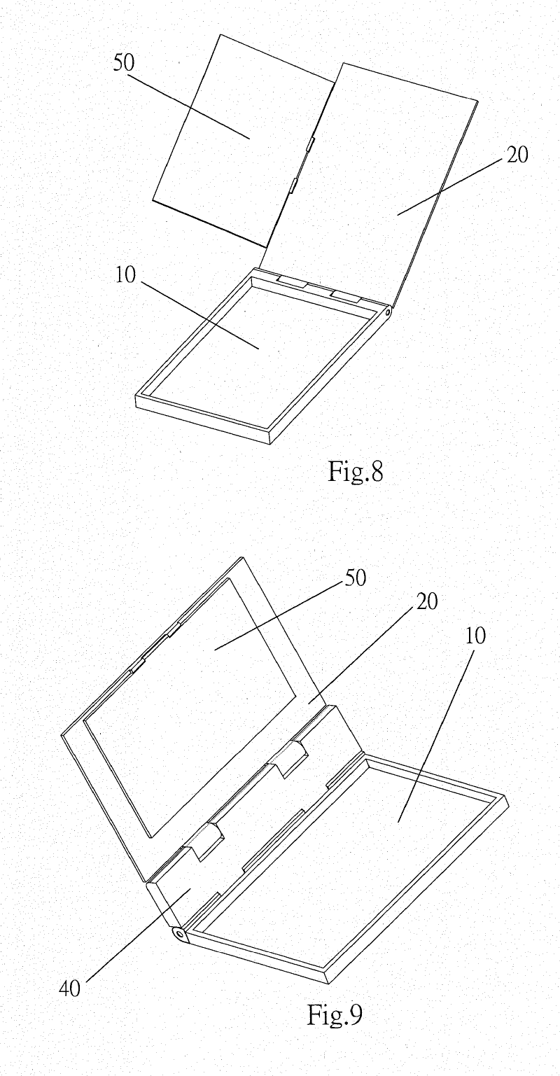

With reference to FIGS. 7 and 8, a rotation track of the mirror assembly may be parallel to that of the cover 20, or the rotation track of the mirror assembly 50 is vertical to that of the cover 20.

It should be noted, in above description, the box body 10, the cover 20 and the mirror assembly 50 are illustrated with rectangular shapes, however, this is not used to confine the scope of the present invention. Referring to 13, it is illustrated that in this the present invention, they may have circular shapes, or others.

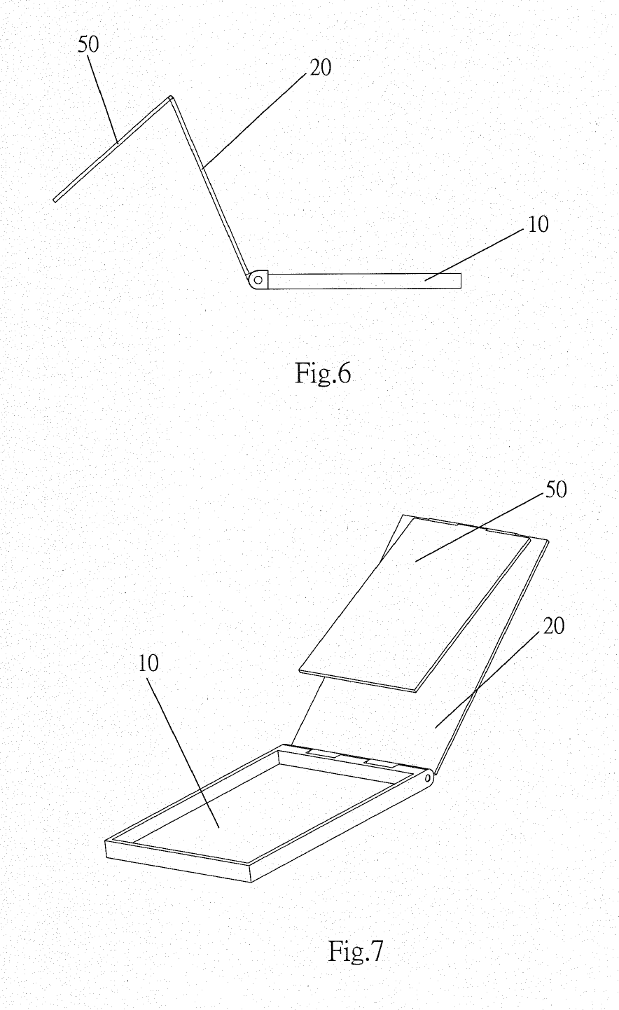

In this embodiment, the rotation trace of the cover 20 along the box body 10 may be larger than 180 degrees, as illustrated in FIG. 5. Similarly, the rotation trace of the mirror assembly 50 along the cover 20 may be larger than 180 degrees, as illustrated in FIG. 6.

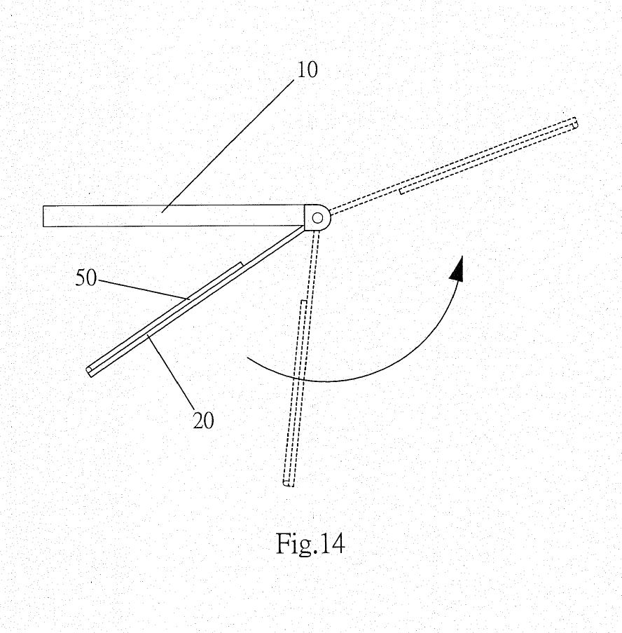

With reference to FIG. 14, it is illustrated that the cover 20 may cover a backside of the box body 10. The shape of the box body 10 may be suitable to that of a tablet electronic device so that the tablet electronic device may be received in the receiving shape of the box body 10. In use, the cover 20 is open from the backside of the box body 10 and the mirror assembly 50 installed on the cover 20 is lifted.

In mechanism, there are many ways for forming above mentioned pivotal portion 30 so that the cover 20 can be positioned at a desired angle with respect to the box body 10. In above mentioned embodiment, a pivotal shaft is used in description, however, this way is not used to confine the scope of the present invention. Other ways such as tightening engagement of pivotal shafts; tightening engagement of tenons; tightening engagement of tube connections; friction engagement of pivotal shafts; and flexible metal connection, etc., are also within the scope of the present invention.

With reference to FIG. 11, a tightening tenon connection is provided, in that a plurality of shafts are provided, while some shafts have tenons and other shafts have recesses for receiving the tenons so that the tenons are tightly engaged into the recesses, while the tenons are rotatable in recesses.

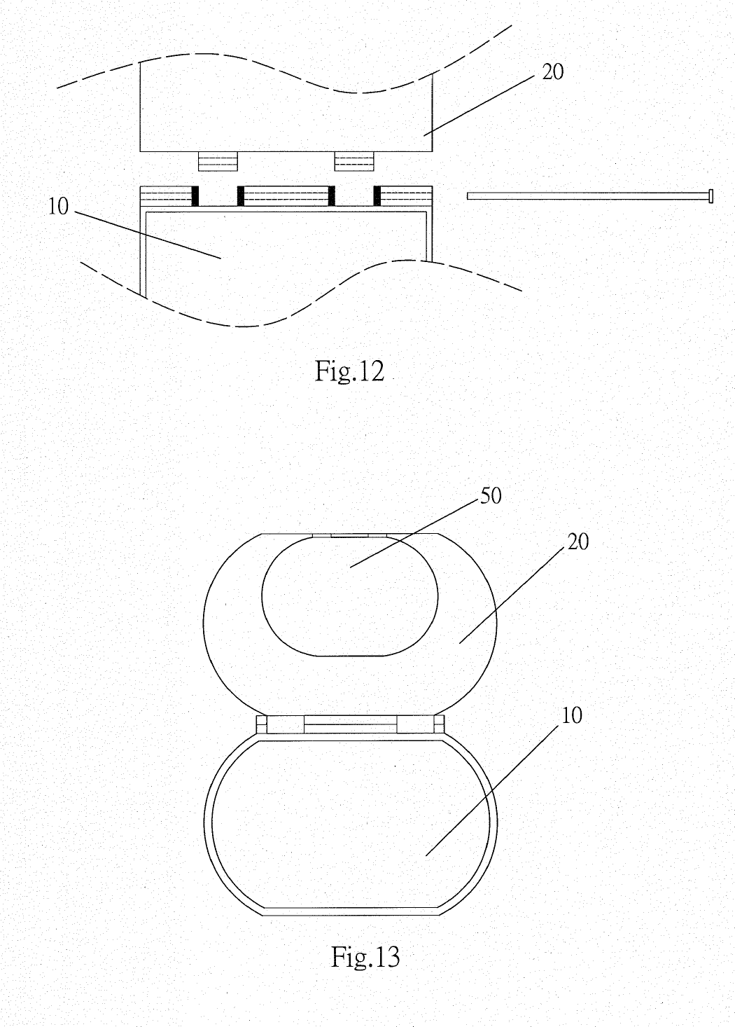

With reference to FIG. 12, a tightening shaft connection or friction connection is provided. In this embodiment, a rotation shaft, a plurality of rings and a plurality of friction units (friction washings) are provided. The rotation shaft is tightly surrounded by the rings by using thread-engagement, while the rotation shaft is rotatable therealong. Preferably, the friction washings are installed between the rotation shaft and the rings. The friction force therebetween is controlled by the locking the design of the friction force and thus this way provides a preferred angle control.

Advantages of the present invention are that the mirror assembly, the cover, the box body are combined by the pivotal portion and the pivotal unit so that they are formed as an integral body, while they can be opened desired angles and fixed at that angles. Therefore, the bag of the present invention has both the function of receiving a tablet electronic device and providing mirror images by using the mirror assembly. The pivotal portion may be positioned at a desired angle with respect to the box body without falling down to an original position, and moreover, the pivotal portion can be opened at different orientations. Furthermore, in the present invention, the mirror assembly is pivotally connected to the cover and can be positioned at a desired angle with respect to the box body. Therefore, a user can lift the mirror assembly from the cover to get the related image from the mirror assembly.

The present invention is thus described, it will be obvious that the same may be varied in many ways. Such variations are not to be regarded as a departure from the spirit and scope of the present invention, and all such modifications as would be obvious to one skilled in the intended to be included within the scope of the following claims.

What is claimes is:

1. A multi-functional tablet electronic device receiving bag, comprising:
a box body having a receiving space for receiving a tablet electronic device;
a cover for covering upon the box body from a front side or a back side of the box body;
pivotal portion installed between the box body and the cover for connecting the box body to the cover; the pivotal portion serving to cause that when the cover is opened from the box body, it can be retained at a predetermined angle and does not fall down to cover the box body again; and
a mirror assembly pivotal to the cover so that the mirror assembly is rotatable along the cover and can be positioned at a predetermined angle.

2. The multi-functional tablet electronic device receiving bag claimed in claim 1, wherein the tablet electronic device is one of a handset and a tablet computer.

3. The multi-functional tablet device receiving bag as claimed in claim 1, wherein the pivotal portion comprises:
a box side pivotal unit; and
a cover side pivotal unit pivotal to the box side pivotal unit so that the cover side pivotal unit is rotatable along the box side pivotal unit to a predetermined angle and then that the cover being fixable at that angle without covering the box body again.

4. The multi-functional tablet electronic device receiving bag as claimed in claim 1, wherein the pivotal portion comprises:
a box side pivotal unit;
a cover side pivotal unit; and
a connecting portion connected between the box side pivotal unit and the cover side pivotal unit; the box side pivotal unit being pivotal to one side of the connecting portion, and the cover side pivotal unit being pivotal to an opposite side of the connecting portion so as to provide a great volume for receiving the electronic device therein.

5. The multi-functional tablet electronic device receiving bag as claimed in claim 3, wherein the pivotal portion is connected to a longitudinal (long) side of the box body or connected to a transversal (short) side of the box body.

6. The multi-functional tablet electronic device receiving bag as claimed in claim 4, wherein the pivotal portion is connected to a longitudinal (long) side of the box body or connected to a transversal (short) side of the box body.

7. The multi-functional tablet electronic device receiving bag according to 1, wherein the mirror assembly is one of a reflecting mirror, a double-side mirror, a lens, a convex lens and a concave lenses.

8. The multi-functional tablet electronic device receiving bag as claimed in claim 1, wherein one side of the mirror assembly is extended with a connecting unit for connecting the mirror assembly to a pivotal unit at one side of the cover so that the mirror assembly is rotatable with respect to the cover along the pivotal unit.

9. The multi-functional tablet electronic device receiving bag as claimed in claim 3, wherein the mirror assembly is formed at a longitudinal (long) side of the cover or at a transversal (short) side of the cover.

10. The multi-functional tablet electronic device receiving bag as claimed in claim 4, wherein the mirror assembly is formed at a longitudinal (long) side of the cover or at a transversal (short) side of the cover.

11. The multi-functional tablet electronic device receiving bag as claimed in claim 8, wherein a rotation track of the mirror assembly 50 is parallel to that of the cover, or the rotation track of the mirror assembly is vertical to that of the cover.

12. The multi-functional tablet electronic device receiving bas as claimed in claim 1, wherein a trace of the cover rotating along the box body is larger than 180 degrees.

13. The multi-functional tablet electronic device receiving bag as claimed in claim 1, wherein a trace of the mirror assembly rotating along the cover is larger than 180 degrees.

14. The multi-functional tablet electronic device receiving bag as claimed in claim 1, wherein the pivotal portion is performed by one of tightening engagement of pivotal shafts; tightening engagement of tenons; tightening engagement of tube connections; friction engagement of pivotal shafts; and flexible metal connection.

15. The multi-functional tablet electronic device receiving bag as claimed in claim 1, wherein the cover is able to cover a backside of the box body; a shape of the box body is suitable to that of a tablet electronic device so that the tablet electronic device is receivable in a receiving recess of the box body.
